(19) United States
(12) Patent Application Publication
(10) Pub. No.: US 2005/0110559 A1
(43) Pub. Date: May 26, 2005

(54) Charge pump with reduced noise

(75) Inventors: Thomas Farkas, Marlborough, MA (US); Abram P. Dancy, Shrewsbury, MA (US); Leif E La White, N. Thetford, VT (US); Martin F. Schlecht, Lexington, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: SynQor, Inc., Boxborough, MA (US)

(21) Appl. No.: 10/764,823

(22) Filed: Jan. 26, 2004

Related U.S. Application Data
(63) Continuation-in-part of application No. 10/764,347, filed on Jan. 23, 2004, now abandoned.
(60) Provisional application No. 60/525,058, filed on Nov. 25, 2003.

(51) Int. Cl. G05F 3/02

(52) U.S. Cl. 327/536

(57) ABSTRACT

A charge pump generates gate control voltage in a DC/DC converter. The input voltage to the charge pump may vary. To reduce noise at higher input voltages, a variable resistance is included in the charge pump and that resistance is controlled to vary with the input voltage.

### RELATED APPLICATION

This application is a continuation-in-part of U.S. Application identified by Attorney Docket No. 1465.2017-000 entitled “Charge Pump with Reduced Noise” filed on Jan. 23, 2004 with Thomas Farkas, Abram P. Dancy, Leif E. LaWhite and Martin F. Schlecht as inventors, which claims the benefit of U.S. Provisional Application No. 60/525,058, filed on Nov. 25, 2003. The entire teachings of the above applications are incorporated herein by reference.

### BACKGROUND OF THE INVENTION

Power converters, such as non-isolated DC/DC down converters, are often built using integrated control circuits. These control IC's direct the operation of the power converter's power stage, and they implement various control functions that are required to create a well-behaved power converter under all operating conditions.

One such control function provided by some control IC's is that of a bias supply to provide power to the controller's internal circuitry and to the driver of the power MOSFET gates. The Intersil ISL6526, for example, is specified to operate from supplies of 3V to 5.5V. When operated from supplies of 3V to 3.6V, a bias supply in the form of an internal charge pump is used to generate the higher voltages required for the IC's internal circuitry and for a gate drive voltage that will result in full enhancement of the power MOSFETs. When operated from supplies of 4.5V to 5.5V this charge pump is bypassed and the internal circuitry is powered directly from the input voltage supply.

### SUMMARY OF THE INVENTION

The operation of a charge pump, such as that in the ISL6526 controller, can produce electrical noise. This noise affects the operation of other circuitry both within the controller IC and nearby on the PCB. Artifacts of this noise can cause the power MOSFET switching times to be affected, resulting in excessive input and output ripple, acoustic noise, or other objectionable or erratic behavior.

This document describes methods to reduce the noise generated by a charge pump. Depending on the operating point (Vin, Vout, and Iout), different amounts of noise are generated by a charge pump. The circuitry of this invention monitors this operating point and applies appropriate noise reduction measures, consistent with maintaining the critical operations of the charge pump.

In embodiments of the invention, a charge pump circuit comprises a charge pump capacitance and switches that vary voltage across the pumping capacitance to provide a pumped output voltage from an input voltage. A variable resistance in the circuit is varied with varied operating point of the circuit. The resistance may be nonlinear such as obtained with a field effect transistor or other semiconductor device.

In certain embodiments, the variable resistance is coupled in series with the pumping capacitance and input voltage. It may comprise a switch such as a field effect transistor coupled in parallel with a resistor. Control of the variable resistance may be in response to a comparator, an amplifier or a shunt reference device.

The invention may be applied to a DC/DC converter. The pumped output voltage is applied to a controller that controls switches in the converter.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1, Intersil ISL6526 PWM IC Block Diagram

FIG. 2, Typical Synchroous Buck Converter Built with ISL6526

FIG. 3, Charge Pump Internal Switches

FIG. 4, Charge Pump with Noise-Reducing Resistor, Rt, in series with Pump Capacitor, Ct

FIG. 5, Charge Pump with Current-Limiting Resistor and Comparator-Controlled MOSFET Bypass Switch

FIG. 6, Charge Pump with Linear Regulator

FIG. 7, Charge Pump with Linear Regulator using Shunt Reference

FIG. 8, Charge Pump with Noise-Reducing Resistor, Rt, in series with its Input

FIG. 9, Charge Pump with Noise-Reducing Resistor, Rt, in series with its Output

FIG. 10, Step Down Charge Pump

FIG. 11, Inverting Charge-Pump

FIG. 12, External Charge Pump with Synchronous Buck or Half-Bridge Converter (prior art)

FIG. 13, Circuit with Integrated Resistively Current-Limited Charge Pump for Startup and Regulated External Charge Pump for Steady-State Operation

### DETAILED DESCRIPTION OF THE INVENTION

A description of preferred embodiments of the invention follows.

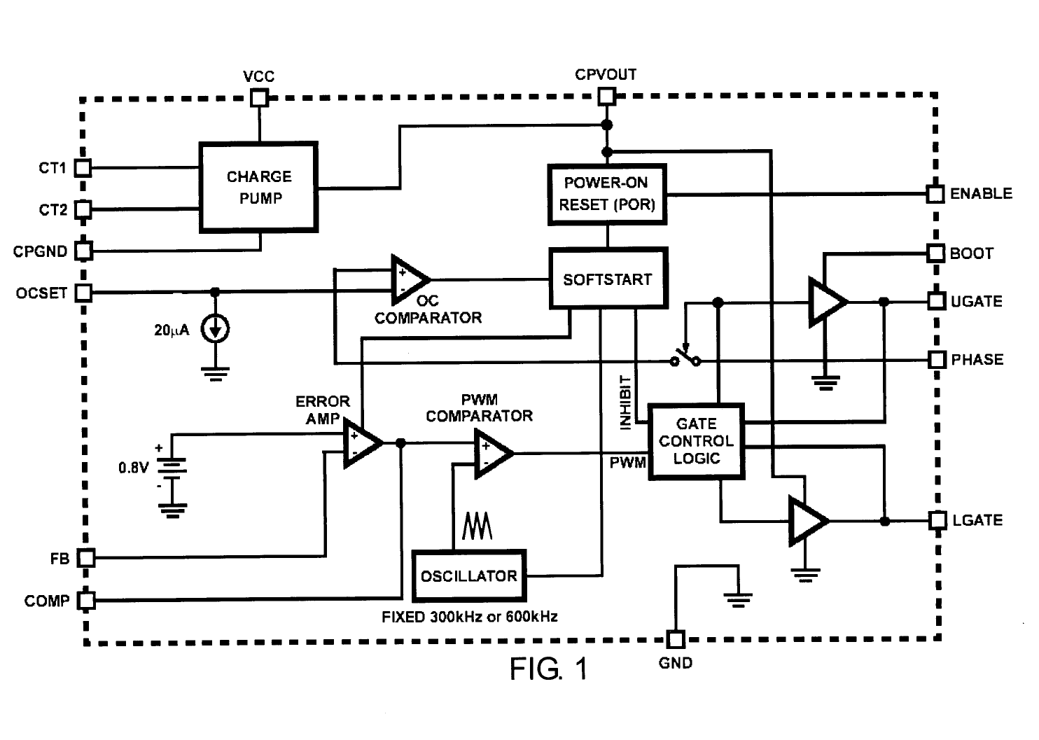

FIG. 1 shows the internal block diagram of a typical PWM controller, this one is Intersil's ISL6526. This control IC is intended for use in constructing synchronous buck DC/DC converters. Input power, Vin, is supplied to the IC via the Vcc pin. Pins Ugate and Lgate drive gates of external power MOSFETs. The IC also contains an internal reference, an error amp, an oscillator, and most of the other circuitry required to perform PWM-controlled switching of the external power MOSFETs.

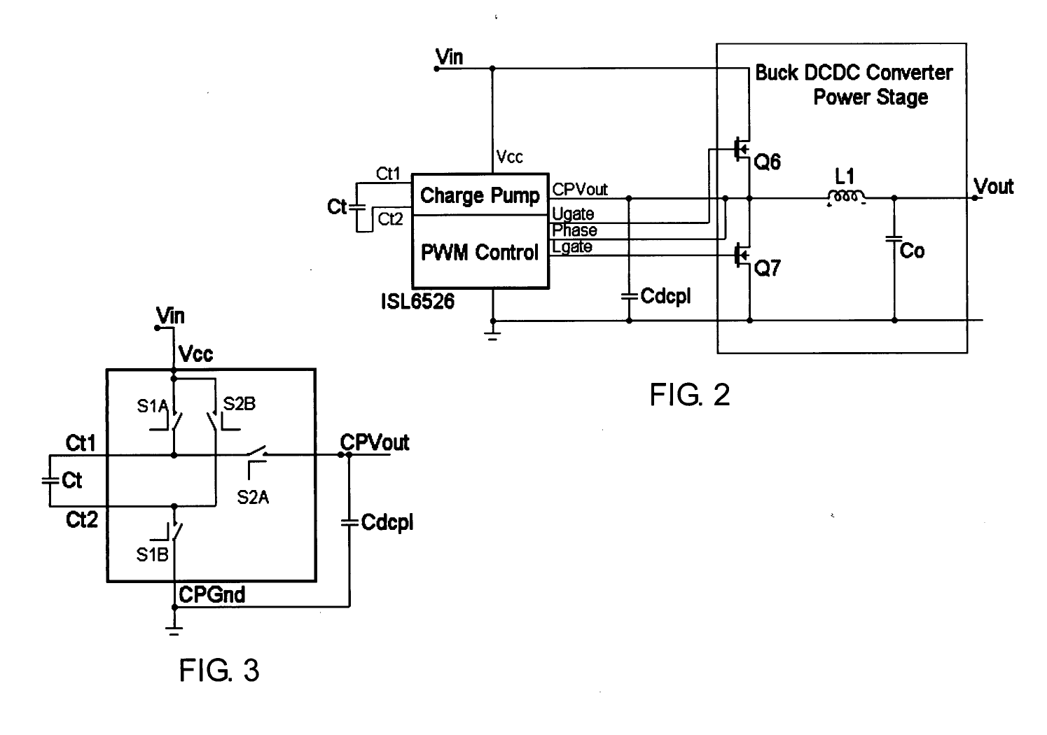

The essence of a typical implementation, that of a synchronous buck DCDC converter using an Intersil ISL6526 control IC, is shown in FIG. 2. Power MOSFETs Q6 and Q7 are turned on alternately, connecting L1 to either Vin or Ground. L1 and Co form a 2^{nd}-order LC filter, smoothing the switching action of Q6 and Q7, and providing an essentially constant voltage, Vout.

Of note is the Charge Pump section of the ISL6526. This charge pump is used to (optionally) raise the IC's internal supply voltage, CPVout, higher than Vin. This is required, in this instance, to properly power the remainder of IC's internal circuitry and to fully enhance external power MOSFETs.

For the purposes of this discussion it is a standard 4-switch charge pump as shown in FIG. 3, but any charge pump may be used. In this instance the Vcc pin is tied to the input source Vin, and CPVout is the charge pump output. This arrangement yields, under normal operating conditions, CPVout>Vin.

There are many ways to control such a charge pump. The simplest is just to alternately open and close switch pairs S1A/S1B and S2A/S2B at a set interval or frequency. When S1A and S1B are closed, pumping capacitance Ct is charged to Vcc, which is normally the input supply voltage, Vin. Then, when S1A/S1B are opened and S2A/S2B are closed, Ct is placed in series with Vin and across CPVout and Cdcpl. If this switching is repeated indefinitely, CPVout will approach 2*Vin. Since it tracks Vin, this simple method doesn't provide regulation of CPVout.

If regulation of CPVout is sought, a simple method to achieve this regulation is to leave the S1A/S1B switches on until the output voltage, CPVout, is determined to be below a minimum threshold. At this time switches S1A/S1B are turned off and switches S2A/S2B are turned on, again placing Ct in series with Vin and across CPVout. A portion of the charge on Ct will be transferred to Cdcpl and this capacitor's voltage will increase in proportion to that charge. When this charge transfer is complete, the S2A/S2B switches are opened and S1A/S1B are re-closed, charging Ct from Vin again. If Ct is small compared to Cdcpl, than the charge transferred from Ct will have only a small (ripple) effect of the voltage across Cdcpl. Ct is left connected across Vin with S1A/S2A until CPVout again decays to its minimum threshold.

In this manner, CPVout will be regulated just above its minimum threshold. Every time it sags to the threshold it is bumped up again by an amount of the charge transferred from Ct. This method of regulation is used, for example, in the charge pump integrated into the Intersil ISL6526 PWM controller.

For mathematical simplicity, assume that Cdcpl is >>Ct and that the ripple on CPVout is small enough to be ignored. When Ct is charged from Vin, it takes on Qchg =Ct*Vin. When it is then connected to Cdpl, a portion of that charge is transferred to Cdpl. When the transfer is complete, Ct will have a voltage of CVPout −Vin on it and thus have charge Qd=Ct*(CPVout−Vin). The difference between those two charges is the amount transferred to Cdcpl: Qt=Ct*(2Vin−CPVout). Of course Qt is the exact same amount of charge that will be put back on Ct when Ct is switched back across Vin.

At the instant of the switching transition, the resistance of the two switches in series, 2*Rsw (and other small parasitics), is the only limitation on the currents that flow. It is classic circuit analysis to derive the equation of the current during a transition:

$$It ( t ) = \frac{2 Vin - CPVout}{2 Rsw} \cdot {ⅇ}^{\frac{- t}{τ}} τ = 2 Rsw \cdot Ct$$

These are exponentially decaying spikes of current. The height of the spike is (2Vin−CPVout)/2Rsw. The frequency of switching also depends on Vin, CPVout, and the current drawn from CPVout, Iout.

$$Fsw = \frac{Iout}{Qt} Fsw = \frac{Iout}{( 2 Vin - CPVout ) \cdot Ct}$$

And the ripple amplitude on CPVout

$$Vripple = ( 2 Vin - CPVout ) \cdot \frac{Ct}{Cdcpl}$$

Note that as Vin decreases to CPVout/2, the current spike and the ripple vanish, but the frequency becomes infinite. On the other hand, as Vin increases to CPVout, the current spikes have height Vin/2Rsw, the ripple is Vin*Ct/,Cdcpl, and the frequency drops to Iout/(Vin*Ct). Given typical circuit values it is quite reasonable to expect the current spike to approach 1 A under these condition. These spikes of varying amplitude and frequency can create significant noise and interference in sensitive circuitry nearby.

The Intersil ISL6526 control IC attempts to overcome the sensitivity of its circuits to the noise spikes by synchronizing the charge pump to the PWM switching. At low Vin, the charge pump switches every PWM cycle, but as Vin rises the pump's frequency must drop to maintain CPVout. The ISL6526 accomplishes this by allowing the charge pump to skip PWM cycles resulting in subsynchronous operation of the charge pump. Any resulting noise appears as a subharmonic disturbance in the circuit control signals and its terminal characteristics. For example, the charge pump's switching frequency may appear as an amplitude modulation signal on the converter's output voltage ripple.

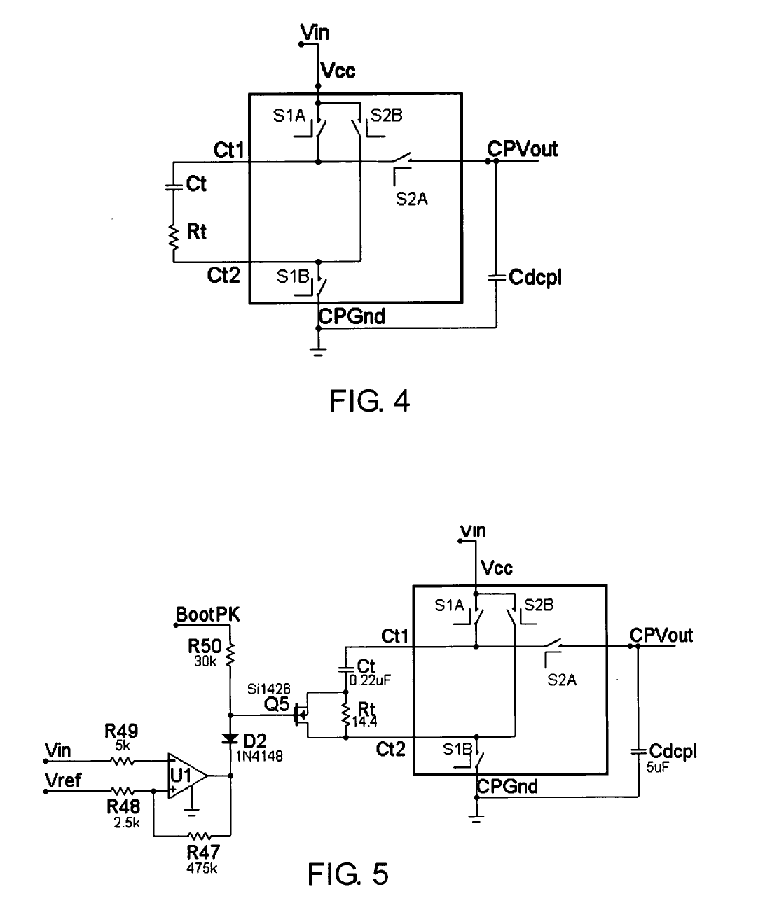

The addition of a resistor, Rt, in series with the charge pump capacitor, Ct, as shown in FIG. 4, serves to reduce the peak noise-generating currents and also force the charge pump to maintain a high switching frequency while operating at higher input voltages.

But Rt's presence limits the charge pump's capability at low input voltages. To accomplish both quiet high-frequency operation at higher input voltages and full-power capability at lower input voltages a variable resistor may be used for Rt. This resistor can be adjusted, with other circuitry, for changes in input voltage, desired output voltage, or output loading.

For example, in FIG. 5, a switching device, such as a MOSFET Q5, is placed in parallel with a fixed current limiting resistor Rt and controlled so as to bypass the resistor when the input voltage is below some threshold. A comparator, U1, is configured so that it pulls down the gate of the bypass FET Q5, turning it off, when the voltage at its inverting input terminal, connected to the input voltage or a scaled representation thereof, exceeds a reference voltage connected to its non-inverting input terminal. In this mode, when Vin is high, the charge pump runs with Rt in series with Ct. When the input voltage is less than the reference level, the MOSFET gate is pulled high, turning on the MOSFET, and shorting out Rt. Though not necessarily required, hysteresis can also be added to the comparator's switching via R47 and R48.

Since the terminals of the switch Q5 will at times be at or near the level of the bias supply voltage, a higher drive voltage may be needed if a device such as an N-channel MOSFET is used. In the embodiment of FIG. 5, the gate of an N-channel MOSFET Q5 is pulled up to a higher voltage which is in this instance generated by peak rectifying a high-side gate drive supply voltage (known as a bootstrap supply to those skilled in the art.)

Note that a MOSFET, with an inherent body diode, has the effect of providing current limiting in one direction only. A four-quadrant switching device, such as a complementary pair of MOSFETs or a JFET (Junction Field Effect Transistor), could be employed if the charge pump current also needs to be limited during the intervals when the charge pump capacitor is connected directly across the input voltage supply.

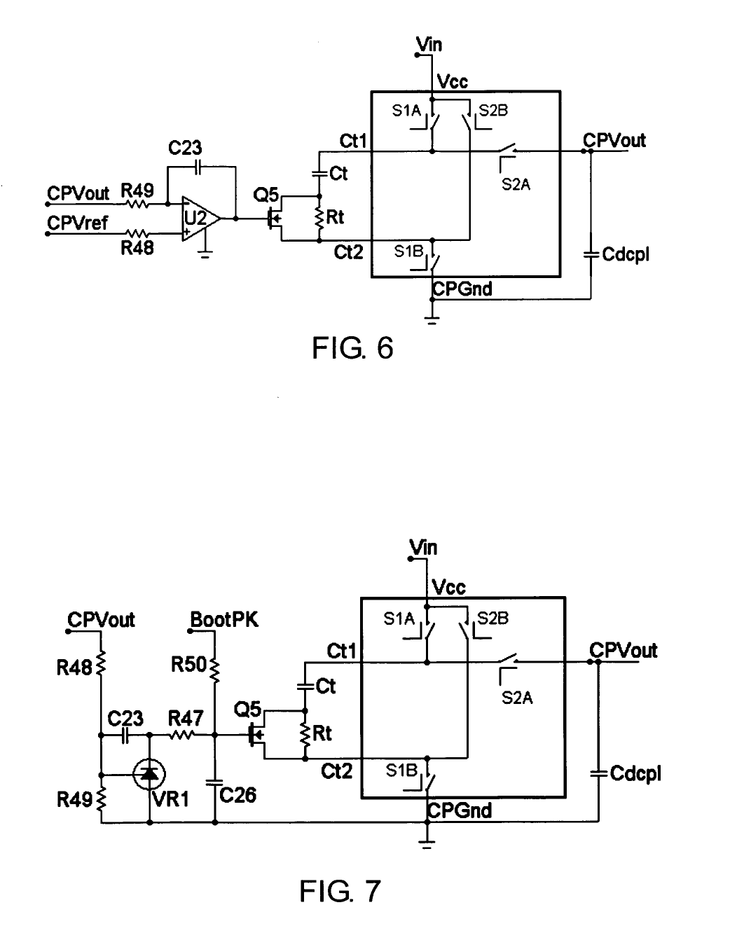

Alternately, the variable resistance in series with the charge pump may take on a continuum of resistance values. For example, the linear regulator embodiment shown in FIG. 6 employs feedback control with op-amp, U2, to drive the MOSFET, Q5, at the DC gate voltage where it has just enough conductance to give a targeted output voltage, CPVref, and maintain synchronous operation. Effectively, a linear regulator has been added in series with the charge pump.

When adding this circuitry to an integrated (i.e., on-chip) hysteretically-controlled charge pump (having only an external capacitor), synchronous operation requires that CPVref be lower than the minimum voltage targeted by the integrated hysteretic controller, so that the controller turns on the internal switches S2A and S2B every cycle.

Resistor Rt is also included so that even if there is insufficient voltage supplying the linear regulator MOSFET initially, a small amount of power can be drawn through the charge pump for startup.

FIG. 7 shows an alternative embodiment of this linear regulator approach, employing shunt reference, VR1, instead of an op-amp to implement the feedback control. VR1 could be any of numerous devices available, such as the National Semiconductor LMV431, which combine the functionality of an op-amp and a voltage reference.

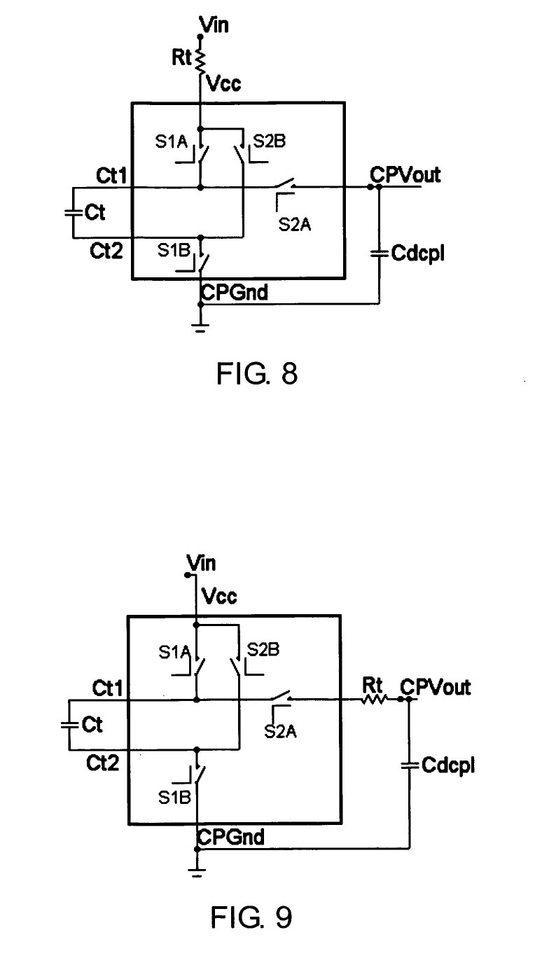

Of significance is that the noise-reducing circuitry might be placed in series with the input (Vin), as shown by Rt in FIG. 8. Though only Rt is shown for brevity, anyone skilled in the art could easily modify all of the foregoing regulating circuits for use with Rt in this position. The input voltage pin of the integrated circuit, however, may have internal connections to other circuitry (besides the charge pump), which require a direct connection to the input voltage source. In this case, placing the noise-reducing circuitry in series with the input source might disturb the operation of other functions of the integrated circuit.

The noise-reducing circuitry might also be placed in series with output (CPVout) of the charge pump, as shown in FIG. 9. Again, only Rt is shown for brevity, and anyone skilled in the art could easily modify all of the forgoing regulating circuits for use with Rt in this position. With an integrated charge pump, however, this may not be feasible, since most of the charge pump load current would be directly drawn by the integrated circuit if, for example, it contains the gate drive circuitry for the power converter.

If the charge pump is separate from its load, that is, if it is not integrated into the PWM, then these alternative placements for the noise-reducing circuitry could well prove advantageous or simpler to implement than the versions presented above where it was placed in series with the pump capacitor, Ct.

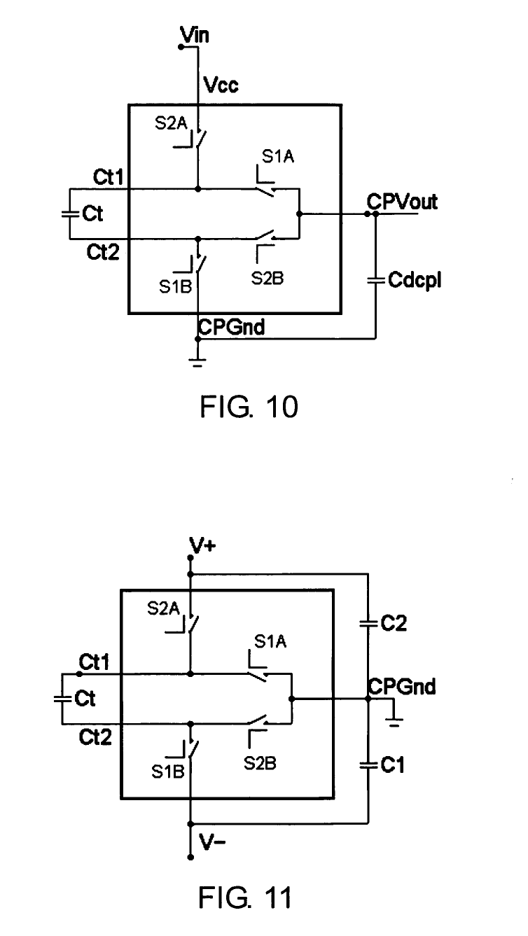

The foregoing discussion concentrated on charge pumps configured as step-up converters where CPVout is normally at a higher potential than the input, Vin, connected to the Vcc pin. This is the normal condition with PWM circuits designed to operate from relatively low input voltages, yet requiring higher bias voltages to operate their own circuitry and/or fully enhance power MOSFET gates. Other electronic circuits may, however, be designed for applications with input voltages too high for their internal circuitry and/or power MOSFET gates. In these applications, a step-down charge pump circuit, as shown in FIG. 10, may be employed. Close examination will show that this is the same circuit as in FIG. 3 with the Vcc and CPVout terminals swapped. This step-down charge pump could cause the same sorts of noise producing current spikes and ripples. The above noise reduction methodologies are entirely applicable to step-down charge pumps as well, and anyone skilled in the art could reconfigure the above noise reduction circuits for use with step-down charge pumps.

A third variant of the charge pump, one that inverts its input voltage polarity, is shown in FIG. 11. Close examination will show that it is identical to that in FIG. 10 with the CPgnd and CPVout terminals swapped. If V+ is supplied, then the pump creates V− and if V− is supplied the pump creates V+. These may have application in multiple output converters, or anytime both positive and negative bias voltages are required. Again, the inverting charge pumps could produce the same electrical noise and nearby circuitry could be similarly affected. Also again, anyone skilled in the art could re-configure the foregoing noise-reducing methodologies for application with inverting charge pumps.

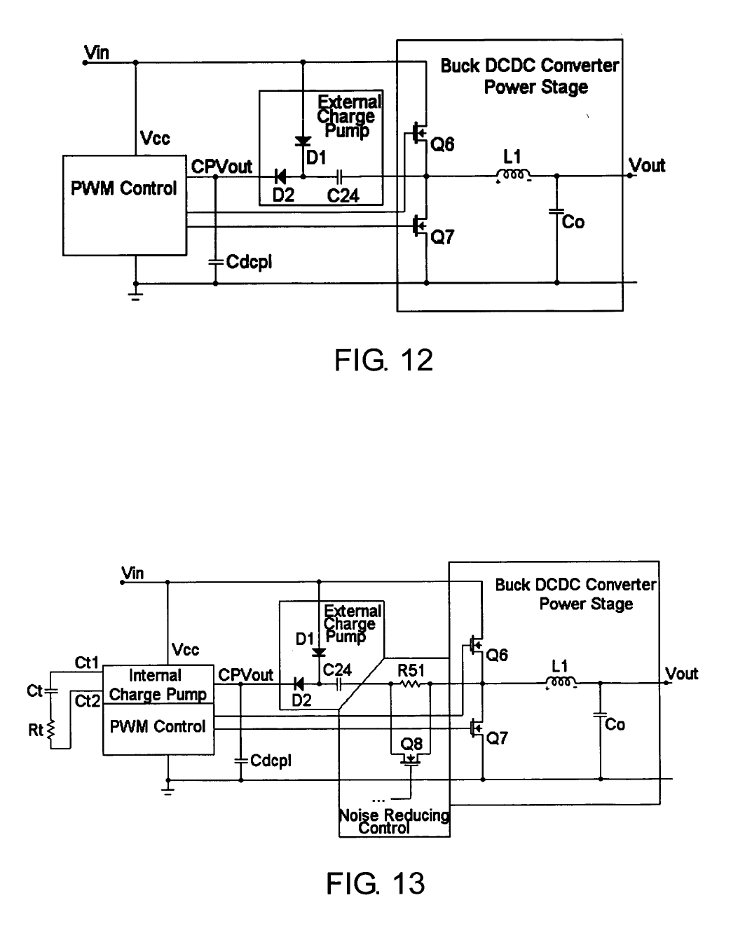

Any of the aforementioned current limiting and feedback control methods can also be used with a non-integrated charge pumps. For example, in circuits with series-connected switches, such as a half-bridge or a synchronous buck converter, it is common to connect a pair of diodes and capacitors with the two main power switches to create a charge pump as shown in FIG. 12, (prior art). Current limiting/noise reducing circuitry could then be inserted in series with the charge pump capacitor C24, or either of the diodes D1 or D2, depending on which current (input or output) needs to be limited.

The charge pump of FIG. 12 only provides the bias supply voltage (larger than Vin) at CPVout when the switch-mode controller operates the main switches Q6 and Q7. However, the controller may need this voltage in order to initiate the switching operation. The controller may therefore include an integrated charge pump but with insufficient capacity or with hysteretic control that results in undesirable subsynchronous operation. A proposed solution is shown in FIG. 13, where both charge pumps are utilized. The integrated charge pump employs a current-limiting resistor, Rt, and the external charge pump utilizes noise-reducing variable conductors, R51/Q8, in any of the noise reducing strategies outlined in FIG. 4 through FIG. 6.

While the circuit solutions shown in the document could be constructed external to the control IC, they could also be contained within the control.

This invention may be used in conjunction with “Charge Pump Bypass” filed on Jan. 26, 2004 with Thomas Farkas, Abram P. Dancy, Leif E. LaWhite and Martin F. Schlecht as inventors.

While this invention has been particularly shown and described with references to preferred embodiments thereof, it will be understood by those skilled in the art that various changes in form and details may be made therein without departing from the scope of the invention encompassed by the appended claims.

1. A charge pump circuit comprising:
charge pumping capacitance;
switches that vary voltage across the pumping capacitance to provide a pumped output voltage from an input voltage;
variable resistance; and
control that varies the variable resistance with varied operating point.

2. A charge pump as claimed in claim 1 wherein the variable resistance is coupled in series with the pumping capacitance and input voltage.

3. A charge pump as claimed in claim 1 wherein the variable resistance comprises a switch coupled in parallel with a resistor.

4. A charge pump as claimed in claim 3 wherein the switch is a field effect transistor.

5. A charge pump as claimed in claim 3 wherein the control comprises a comparator.

6. A charge pump as claimed in claim 3 wherein the control comprises an amplifier.

7. A charge pump as claimed in claim 3 wherein the control comprises a shunt reference device.

8. A charge pump as claimed in claim 1 wherein the variable resistance comprises a field effect transistor.

9. A charge pump as claimed in claim 1 wherein the control comprises a comparator.

10. A charge pump as claimed in claim 1 wherein the control comprises an amplifier.

11. A charge pump as claimed in claim 1 wherein the control comprises a shunt reference device.

12. A controller comprising:
charge pumping capacitance;
switches that vary voltage across the pumping capacitance to provide a pumped output voltage from an input voltage;
variable resistance; and
control that varies the variable resistance with varied operating point.

13. A controller as claimed in claim 12 comprising both a charge pump internal to a controller integrated circuit and an external charge pump.

14. A controller as claimed in claim 12 wherein the variable resistance is coupled in series with the pumping capacitance and input voltage.

15. A controller as claimed in claim 12 wherein the variable resistance comprises a switch coupled in parallel with a resistor.

16. A controller as claimed in claim 15 wherein the switch is a field effect transistor.

17. A controller as claimed in claim 15 wherein the control comprises a comparator.

18. A controller as claimed in claim 15 wherein the control comprises an amplifier.

19. A controller as claimed in claim 15 wherein the control comprises a shunt reference device.

20. A controller as claimed in claim 12 wherein the variable resistance comprises a field effect transistor.

21. A controller as claimed in claim 12 wherein the control comprises a comparator.

22. A controller as claimed in claim 12 wherein the control comprises an amplifier.

23. A controller as claimed in claim 12 wherein the control comprises a shunt reference device.

24. A DC/DC converter comprising:
controlled switches; and
a controller that controls the controlled switches, the controller comprising:
charge pumping capacitance;
switches that vary voltage across the pumping capacitance to provide a pumped output voltage to the controller from an input voltage;
variable resistance; and
control that varies the variable resistance with varied operating point.

25. A DC/DC converter as claimed in claim 24 comprising both a charge pump internal to a controller integrated circuit and an external charge pump.

26. A DC/DC converter as claimed in claim 24 wherein the variable resistance is coupled in series with the pumping capacitance and input voltage.

27. A DC/DC converter as claimed in claim 24 wherein the variable resistance comprises a switch coupled in parallel with a resistor.

28. A DC/DC converter as claimed in claim 27 wherein the switch is a field effect transistor.

29. A DC/DC converter as claimed in claim 27 wherein the control comprises a comparator.

30. A DC/DC converter as claimed in claim 27 wherein the control comprises an amplifier.

31. A DC/DC converter as claimed in claim 27 wherein the control comprises a shunt reference device.

32. A DC/DC converter as claimed in claim 24 wherein the variable resistance comprises a field effect transistor.

33. A DC/DC converter as claimed in claim 24 wherein the control comprises a comparator.

34. A DC/DC converter as claimed in claim 24 wherein the control comprises an amplifier.

35. A DC/DC converter as claimed in claim 24 wherein the control comprises an shunt reference device.

36. A method of charge pumping comprising:
varying voltage across a pumping capacitor to provide a pumped output voltage from an input voltage; and
varying variable resistance in circuit with the pumping capacitance with varied operating point.

37. A method as claimed in 36 wherein the variable resistance is coupled in series with the pumping capacitance and input voltage.

38. A method as claimed in 36 wherein the variable resistance comprises a field effect transistor.

39. A method as claimed in 36 wherein the variable resistance is varied in response to a comparator.

40. A method as claimed in 36 wherein the variable resistance is varied in response to an amplifier.

41. A method as claimed in 36 wherein the variable resistance is varied in response to a shunt reference device.

42. A method of converting DC voltage to DC voltage comprising:
varying voltage across a pumping capacitor to provide a pumped output voltage from an input voltage;
varying variable resistance in circuit with the pumping capacitance with varied operating point;
applying the output voltage to a controller; and
controlling converter switches from the controller.

43. A method as claimed in 42 wherein the variable resistance is coupled in series with the pumping capacitance and input voltage.

44. A method as claimed in 42 wherein the variable resistance comprises a field effect transistor.

45. A method as claimed in 42 wherein the variable resistance is varied in response to a comparator.

46. A method as claimed in 42 wherein the variable resistance is varied in response to an amplifier.

47. A method as claimed in 42 wherein the variable resistance is varied in response to a shunt reference device.

48. A charge pump comprising:
means for varying voltage across a pumping capacitor to provide a pumped output voltage from an input voltage; and
means for varying variable resistance in circuit with the pumping capacitance with varied operating point.

49. A controller comprising:
means for varying voltage across a pumping capacitor to provide a pumped output voltage from an input voltage; and
means for varying variable resistance in circuit with the pumping capacitance with varied operating point.

50. A DC/DC converter comprising:
means for varying voltage across a pumping capacitor to provide a pumped output voltage from an input voltage;
means for varying variable resistance in circuit with the pumping capacitance with varied input voltage;
means for applying the output voltage to a controller; and
means for controlling converter switches from the control.
